(19) United States
(12) Patent Application Publication
(10) Pub. No.: US 2006/0059502 A1
(43) Pub. Date: Mar. 16, 2006

(54) Machine suitable for placing a component on a substrate, as well as a method therefor

(76) Inventors: Hubert Gerard Jean Joseph Amaury Vroomen, Eindhoven (NL); Peter Ferdinand Greve, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/541,984

(22) PCT Filed: Jan. 12, 2004
(86) PCT No.: PCT/IB04/50004

§ 371 Date: Jul. 11, 2005

(30) Foreign Application Priority Data
Jan. 14, 2003 (EP) 03100051.6

(51) Int. Cl. G11B 7/24

(52) U.S. Cl. 720/718

(57) ABSTRACT

Machine (1) comprising a placement element (7) connected to an imaging device (6), and comprising an optical system (4) for detecting the position of a component (16) relative to the placement element (7) by means of the imaging device (6). The optical system (4) comprises at least one marking element (11). The marking element (11) and the component (16) can be displayed simultaneously by means of the optical system (4) in an image (17) to be made by means of the imaging device (6).

The invention relates to a machine suitable for placing a component on a substrate, the machine comprising an imaging device, a placement element connected to the imaging device, as well as an optical system for detecting the position of the component supported by the placement element by means of the imaging device.

The invention also relates to a method for placing a component on a substrate by means of a machine, the component being picked up by means of a placement element, then, by means of an imaging device and an optical system, an image being made of the component picked up by means of the placement element, after which the component is placed on the substrate.

In such a machine and method known from international patent application WO 97/22237, a component is picked up by a placement element and then taken to a position located above an optical system. By means of the optical system the component is displayed in the imaging device connected to the placement element. From the image made by means of the imaging device, the position of the component relative to the placement machine is determined after which the component is placed in a desired position on a substrate.

A disadvantage of the known machine is that the placement element and the imaging device connected thereto are to be positioned accurately relative to the optical system to be able to accurately determine the position of the component relative to the placement element.

In addition, the position of the component relative to the optical system connected to the fixed world cannot be accurately determined in this manner.

It is an object of the present invention to provide a machine by which the position of the component can be determined accurately and relatively rapidly.

This object is achieved by the machine according to the invention in that the optical system comprises at least a marking element, in which, in operation, the marking element and the component can be displayed simultaneously by means of the optical system in an image to be made by means of the imaging device.

Since both the component and the marking element connected to the optical system are visible in the image and the position of the marking element relative to the optical system is accurately known, the position of the component relative to the optical system at the time when the image is made can be determined accurately from the image. In addition, if the position of the placement element at the time of the image made is also known, also the position of the component relative to the placement element can be determined.

Furthermore, by means of the imaging device it is possible to produce an image of part of a substrate so as to determine the desired positioning spot of the component on the substrate.

Once the relative positions of a component and a substrate are known from the two images, the component can be placed on the desired spot on the substrate.

An embodiment of the machine according to the invention is characterized in that the machine comprises at least a calibration marking element, in which the marking element is located in a first focal plane whereas the calibration marking element is located in a second focal plane, which marking elements, in operation, can be displayed simultaneously in an image to be made by means of the imaging device.

When the image is made, the calibration marking element is located in predetermined positions relative to the optical system. On the basis of this a certain mutual position between the marking element and the calibration marking element is expected in the image. If deviations then occur, the optical system and the imaging device should be checked and corrected until the calibration marking element in the image has an expected position relative to the marking element. Alternatively it is possible to take the deviations established into account when the component is placed on the substrate.

A further embodiment of the machine according to the invention is characterized in that the placement element comprises a marking element connected to the placement element, which marking element, in operation, can be displayed simultaneously with the component in an image made by means of the imaging device.

When the image of the component is made by means of the imaging device, the position of the placement element need not be known. Since the placement element and the connected marking element and the imaging device are interconnected, the marking element connected to the placement element is located in a predefined and fixed position relative to the imaging device. From the image made by the imaging device, in which image the marking element, the component and the marking element connected to the placement element can be displayed simultaneously, the position of the component and of the placement element relative to the optical system can be accurately determined. In this way both the position of the component relative to the “fixed world” and the position of the component relative to the placement element can thus be determined.

Yet a further embodiment of the machine according to the invention is characterized in that the marking element connected to the placement element can be optically displayed in a plane in which there is a component during operation.

In this fashion the marking element connected to the placement element is not physically in the plane in which the component is located, so that the marking element will not collide with the substrate when the component is placed on the substrate. Since the marking element can indeed be optically displayed in this plane, both the component and the marking element will be clearly visible in the image.

Yet a further embodiment of the machine according to the invention is characterized in that the imaging device comprises a marking element connected to the imaging device, which marking element, in operation, can be displayed simultaneously with the marking element connected to the optical system in an image made by means of the imaging device.

The marking element connected to the imaging device will have a predefined position in the image. If, however, some deviations do occur, this may be an indication that the imaging device does not operate properly and is to be checked.

The invention also relates to a method for placing a component on a substrate by means of the machine, with which in a simple and relatively fast manner the position of a component relative to a placement element can be determined.

This object is achieved with the method according to the invention in that in the image a marking element connected to the optical system as well as the component is displayed after which the position of the component relative to the optical system is determined by means of the marking element.

From the image can therefore be determined in an accurate and fast manner the position of the component relative to the marking element and therefore relative to the optical system.

An embodiment of the method according to the invention is characterized in that a further image is made by means of the imaging device, from which further image the desired position of the component on the substrate is determined, after which the component is placed on the desired position.

The position of the substrate relative to the imaging device is determined from the further image. From the two images the position of the component relative to the substrate can be determined, after which the component is placed in the desired position on the substrate by means of the placement element.

These and other aspects of the invention are apparent from and will be elucidated with reference to the embodiments described hereinafter.

In the drawings:

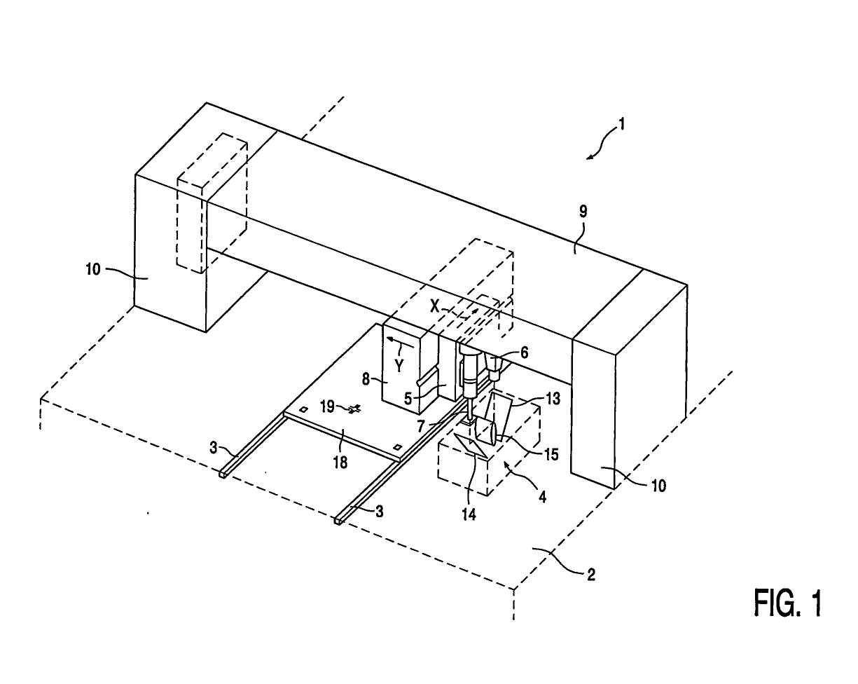

FIG. 1 shows a perspective view of a machine according to the invention,

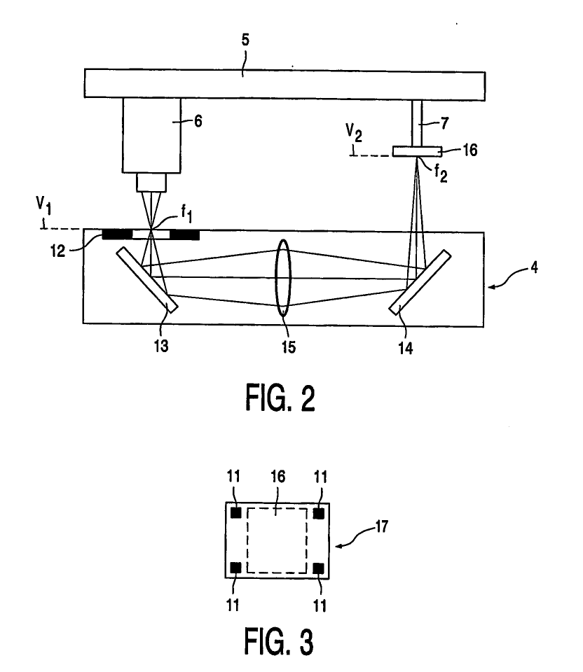

FIG. 2 shows a diagrammatic side elevation of part of a first embodiment of the machine shown in FIG. 1,

FIG. 3 shows an image produced by means of the device shown in FIG. 2,

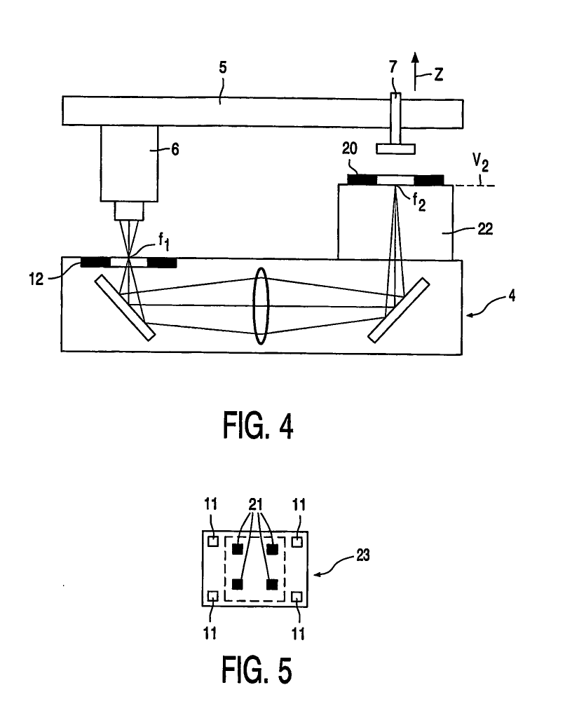

FIG. 4 shows a diagrammatic side elevation of part of a second embodiment of the machine shown in FIG. 1,

FIG. 5 shows an image produced by means of the machine according to the invention shown in FIG. 4,

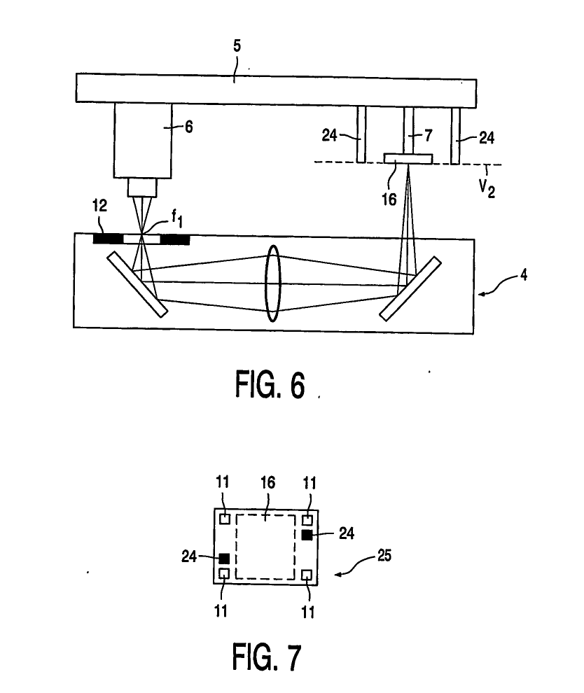

FIG. 6 shows a diagrammatic side elevation of part of a third embodiment of the machine shown in FIG. 1,

FIG. 7 shows an image made by means of the device shown in FIG. 6,

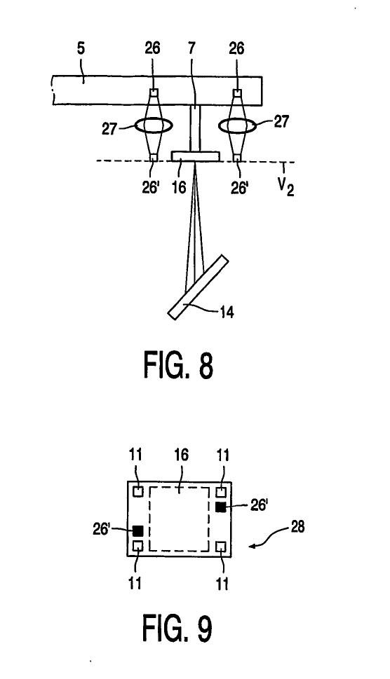

FIG. 8 shows a diagrammatic side elevation of part of a fourth embodiment of the machine shown in FIG. 1,

FIG. 9 shows an image produced by means of the device shown in FIG. 8,

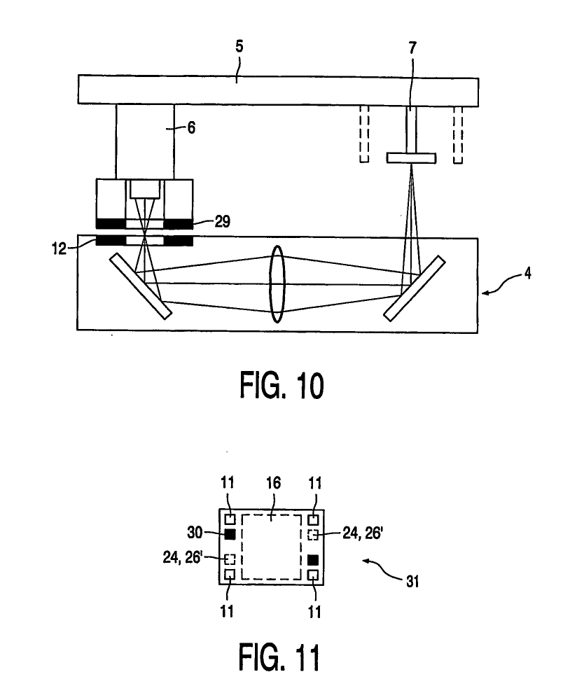

FIG. 10 gives a diagrammatic side elevation of part of a fifth embodiment of the machine shown in FIG. 1,

FIG. 11 shows an image made by means of the device shown in FIG. 10.

Like components in the Figures have like reference characters.

FIG. 1 shows a machine 1 according to the invention, which comprises a frame 2, transport rails 3 supported by the frame 2, an optical system 4 positioned on the side of the transport rails 3 and a unit 5 that is movable above the transport rails 3 and the optical system 4, an imaging device 6 and a placement element 7 together being connected to the movable unit 5. The unit 5 can be moved in and opposite to the direction indicated by the arrow X relative to a slide 8. The slide 8 can be moved in and opposite to the direction indicated by the arrow Y relative to a U-shaped frame 9. The U-shaped frame 9 rests with two legs 10 on the frame 2.

The machine described thus far is known per se, for example from international patent application WO 97/22237 mentioned in the opening paragraph.

The optical system 4 of the machine 1 according to the invention comprises a marking plate 12 (see FIGS. 2, 4, 6, 10) with marking elements 11. The marking plate 12 is preferably made of glass in which, for example, square marking elements 11 are provided.

The marking plate 12 extends in parallel with an X, Y plane. A first reflecting element 13 arranged at an angle of 45% relative to the vertical is positioned underneath the marking plate 12. The optical system 4 further comprises a second reflecting element 14 which also encloses a 45% angle to the vertical. A lens 15 is inserted between the reflecting elements 13, 14.

As FIG. 2 shows, a first focal point f1 is located in a first focal plane V1 which extends through the marking plate 12 when the imaging device 6 has the position relative to the optical system 4, which position is shown in FIG. 2. The lens 15 provides a second focal point f2 which is located in a focal plane V2 which extends in parallel with the first focal plane V1. As is shown in FIG. 2 the placement element 7 with a component 16 attached thereto and with the position of the imaging device 6 shown therein, is located such that the second focal plane V2 extends through the component 16.

If an image is made by means of the imaging device 6, an image 17 shown in FIG. 3 is obtained in which both the marking elements 11 and the components 16 are simultaneously visible. Since the positions of the marking elements 11 relative to the optical system 4 and, therefore, relative to the frame 2 are known, the position of the component 6 relative to the marking elements 11 and therefore relative to the frame 2 can be determined from the image shown in FIG. 3. The unit 5 is driven by means of a driving unit (not shown) by means of which the actual position of the frame 5 and therefore of the placement element 7 relative to the frame is known at any moment, thus also at the moment where the image 17 is made. Therefore, the mutual position of the component 16 relative to the placement element 7 can be derived from the position of the placement element 7 relative to the frame 2 and the position of the component 16 relative to the frame 2.

By means of the camera 6 an image can also be made of a substrate 18 supported by the transport rails 3 (FIG. 1). From the two images can then be determined in what way the unit 5 is to be driven to be able to place the component 6 supported by the placement element 7 on the desired position 19 on the substrate 18.

FIG. 4 shows a second embodiment of a machine 1 according to the invention which comprises, in addition to the component parts shown in FIG. 2, a calibration marking plate 21 which includes calibration marking elements 20. The calibration marking plate 20 is preferably made of glass. The calibration marking plate 20 is detachably positioned on the optical system 4 by means of a support block 22, the second focal plane V2 extending through the calibration marking plate 20. To avoid collision between the placement element 7 and the calibration marking plate 20, the placement element 7 is moved in the upward direction indicated by the arrow Z.

If an image is made by means of the imaging device 6, the image 23 shown in FIG. 5 is obtained in which the marking elements 11 and the calibration marking elements 21 are simultaneously visible. Since both the marking elements 11 and the calibration marking elements 21 have a predetermined position relative to the optical system 4 and the frame 2, in the event of a deviation in the image 23 between the expected and real mutual positions of the marking elements 11 and the calibration marking elements 21, there may be derived that the imaging device 6 and/or the optical system 4 does not function optimally and is therefore to be checked.

It is alternatively possible to take the differences found into account instead when the component is placed on the substrate.

Therefore, the mutual positions of the focal point f1 located in the first focal plane V1 and the focal point f2 located in the second focal plane V2 are determined and checked by means of the calibration elements.

Once the calibration marking elements 21 and the marking elements 11 have a mutually desired position in the image 23, the block 22 and the calibration marking plate 20 connected thereto can be removed. The calibration can again be carried out at any point of time desired by the user.

FIG. 6 shows a third embodiment of a machine 1 according to the invention which, in addition to the elements shown in FIG. 2, comprises two pins 24 extending in parallel with the placement element 7, which pins are connected to one end to the unit 5 and with ends turned away from the unit 5 are located in the second focal plane V2.

If an image is made by means of the imaging device 6, the image 25 shown in FIG. 7 is obtained. In the image 25 are simultaneously visible the marking elements 11, the component 16 and the pins 24 connected to the unit 5. From the image 25 can therefore be derived not only the position of the component 16 relative to the marking elements 11 and thus relative to the frame 2 but, in addition, the position of the unit 5 and the connected placement element 7 can be derived from the positions of the pins 24 relative to the marking elements 11. In this way the position of the unit 5 need not be measured separately when the image is made, but can be directly derived from the image 25.

FIG. 8 shows a fourth embodiment of a machine 1 according to the invention, which machine distinguishes itself from the machine shown in FIG. 6 in that in lieu of pins 24 use is made of two markings 26 which are displayed in the second focal plane V2 as marking elements 26′ via a lens 27. When an image 7 is made by the imaging device 6, image 28 shown in FIG. 9 is obtained, in which the marking elements 11, the components 16 and the virtual marking elements 26′ are simultaneously visible. From this image 28 can again be derived both the position of the component 16 and the position of the unit 5 and the connected placement element 7 relative to the frame 2. The machine shown in FIG. 8 is advantageous in that when the component 16 is placed on the substrate 18 the marking elements 26 cannot collide with the substrate 18 or components already placed thereon. This risk does occur with the machine with the pins 24 shown in FIG. 6. This risk may also be avoided if the component 16 is moved in downward direction relative to the pins 24 when the component 16 is placed on the substrate.

FIG. 10 shows a further embodiment of the machine 1 according to the invention which, in addition to the elements present in FIG. 6 or 8, comprises a marking plate 29 connected to the imaging device 6, which marking plate includes marking elements 30. The marking plate 29 is preferably made of glass. When the image is made by the imaging device 6, the image 31 shown in FIG. 11 is obtained in which both marking elements 11, the component 16, the marking elements 24, 26′ and the marking elements 30 are visible. From this image 31 both the position of the component 16 relative to the frame 2 and the position of the unit 5 relative to the frame 2 can be checked while in addition the correct functioning of the imaging device 6 can be derived from the mutual positions of the marking elements 30 and the marking elements 11. These marking elements 11, 30 should have a predetermined mutual position relative to each other. If deviations occur, this points at deviations in the imaging device 6 after which the imaging device 6 is to be checked or this should be taken into account when the unit 5 is driven.

Alternatively, it is possible to manufacture the marking plate of a plastic transparent material.

In lieu of the one lens 15 it is also possible to use a number of lenses. A lens may also be positioned between the marking plate and a reflecting element. The angles of the reflecting elements may be smaller or larger than 45%. The angles together are preferably 90%. The focal planes V1 and V2 are preferably at the same level as the substrate.

1. A machine suitable for placing a component on a substrate, the machine comprising an imaging device, a placement element connected to the imaging device, as well as an optical system for detecting the position of the component supported by the placement element by means of the imaging device, characterized in that the optical system comprises at least a marking element, in which, in operation, the marking element and the component can be displayed simultaneously by means of the optical system in an image to be made by means of the imaging device.

2. A machine as claimed in claim 1, characterized in that the machine comprises at least a calibration marking element, in which the marking element is located in a first focal plane whereas the calibration marking element is located in a second focal plane, which marking elements, in operation, can be displayed simultaneously in an image to be made by means of the imaging device.

3. A machine as claimed in claim 1, characterized in that the placement element comprises a marking element connected to the placement element which marking element, in operation, can be displayed simultaneously with the component in an image made by means of the imaging device.

4. A machine as claimed in claim 3, characterized in that the marking element connected to the placement element can be optically displayed in a plane in which there is a component during operation.

5. A machine as claimed in claim 1, characterized in that the imaging device comprises a marking element connected to the imaging device, which marking element, in operation, can be displayed simultaneously with the marking element connected to the optical system in an image made by means of the imaging device.

6. A method for placing a component on a substrate by means of a machine, the component being picked up by means of the placement element, then by means of an image device and an optical system an image being made of the component picked up by the placement element, after which the component is placed on the substrate, characterized in that in the image a marking element connected to the optical system as well as the component is displayed after which the position of the component relative to the optical system is determined by means of the marking element.

7. A method as claimed in claim 6, characterized in that a further image is made by means of the imaging device, from which further image the desired position of the component on the substrate is determined, after which the component is placed in the desired position.

8. A method as claimed in claim 6, characterized in that the machine comprises a calibration marking element, in which the marking element is located in a first focal plane, whereas the calibration marking element is located in the second focal plane, which marking elements, in operation, can be displayed simultaneously in an image to be made by means of the imaging device.

9. A method as claimed in claim 6, characterized in that the placement element comprises a marking element rigidly connected to the placement element, which marking element, in operation, can be displayed simultaneously with the component in an image made by means of the imaging device.

10. A method as claimed in claim 6, characterized in that the imaging device comprises a marking element connected to the imaging device which marking element, in operation, is displayed simultaneously with the marking element connected to the optical system in an image made by means of the imaging device.
